(19) United States
(12) Patent Application Publication
(10) Pub. No.: US 2015/0080067 A1
(43) Pub. Date: Mar. 19, 2015

(54) SIZE-ADAPTIVE MOBILE DEVICE COVER

(71) Applicant: BRIGHT HARVEST OVERSEAS INC., TAIPEI CITY (TW)

(72) Inventor: SZU-HAN CHEN, TAIPEI CITY (TW)

(73) Assignee: BRIGHT HARVEST OVERSEAS INC., TAIPEI CITY (TW)

(21) Appl. No.: 14/029,955

(22) Filed: Sep. 18, 2013

(51) Int. Cl. H04B 1/38

(52) U.S. Cl. CPC H04B 1/3888
USPC 455/575.8

(57) ABSTRACT

A size-adaptive mobile device cover has a protection cover with two cover boards and multiple angle holders detachably mounted inside the protection cover. The protection cover serves to carry a mobile device. Each angle holder has two holding sections. A movable fixing portion is detachably mounted on an outer side of one of the holding sections, and is detachably combined with another movable fixing portion on an inner side of one of the cover boards. A holding slot is formed between the two holding sections of each angle holder for holding one corner of the mobile device. As the angle holders can be selectively and detachably mounted on the cover board to hold corners of a mobile device, the size-adaptive mobile device is applicable to mobile devices of various sizes.

### BACKGROUND OF THE INVENTION

1. Field of the Invention

The present invention relates to a mobile device cover, and more particularly to a protection cover adaptive to mobile devices of different sizes.

2. Description of the Related Art

A variety of peripheral products have been constantly introduced to the market as a result of widespread mobile devices, such as tablet personal computers (PC), smart phones, and the like. A conventional protection cover commonly seen in the market primarily serves to receive a mobile device therein to protect the mobile device against collision, scratch, wear, and the like when the mobile device is carried along or is operated. Such protection cover is indeed necessary, especially when the mobile device is costly.

The conventional protection cover takes the form of a book, is standable, and has a first cover board, a second cover board, and a mounting frame. The mounting frame has a receiving bag mounted thereon and having a receiving chamber. The receiving bag has at least one insertion opening formed through one side of the receiving bag and a display opening formed through a top surface of the receiving bag. The first cover board is connected between the mounting frame and the second cover board. Each of the first cover board and the second cover board has multiple folding lines such that the first cover board and the second cover board can be folded for the protection cover to stand up.

Although the foregoing protection cover can receive a mobile device inside the protection cover and protect a mobile device against collision, scratch and wear, the size of the protection cover must fully comply with that of the mobile device. However, most mobile devices in the market are of different sizes. Hence, protection covers of different sizes need to be manufactured to meet such demand. Price hike of the protection covers is also reflected on the incompatibility concern. Besides, even though the receiving chamber of the receiving bag is sufficient to accommodate mobile devices of different sizes, smaller mobile devices may be scratched or collided, or slip out of the receiving bag since the mobile devices are not fully bounded by the protecting cover.

### SUMMARY OF THE INVENTION

An objective of the present invention is to provide a size-adaptive mobile device cover capable of holding mobile devices of various sizes and protecting mobile devices against collision, scratch and wear.

To achieve the foregoing objective, the size-adaptive mobile device cover has a protection cover and multiple angle holders.

The protection cover has two cover boards. One of the cover boards has an inner surface and a first movable fixing portion. The first movable fixing portion is located on the inner surface.

Each angle holder has a second movable fixing portion, and is selectively and detachably mounted on the first movable fixing portion. Locations of the angle holders determine where the first movable fixing portion is located on the cover board on which the first movable fixing portion is formed.

When a mobile device is to be put inside the protection cover of the size-adaptive mobile device cover, two angle holders respectively hold any two diagonal corners of the mobile device and the two angle holders are mounted on the inner side of one of the cover boards. As the angle holders are selectively and detachably mounted on the inner side of the corresponding cover board, the size-adaptive mobile device cover is applicable to mobile devices of various sizes.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a size-adaptive mobile device cover in accordance with the present invention;

FIG. 2A is a perspective view of an angle holder of the size-adaptive mobile device cover in FIG. 1;

FIG. 2B is another perspective view of the angle holder in FIG. 2A;

FIG. 3 is a perspective view of a second embodiment of a size-adaptive mobile device cover in accordance with the present invention;

FIG. 4 is a perspective view of a third embodiment of a size-adaptive mobile device cover in accordance with the present invention;

FIG. 5 is a perspective view of a fourth embodiment of a size-adaptive mobile device cover in accordance with the present invention; and

FIG. 6 is a perspective view of a fifth embodiment of a size-adaptive mobile device cover in accordance with the present invention.

### DETAILED DESCRIPTION OF THE INVENTION

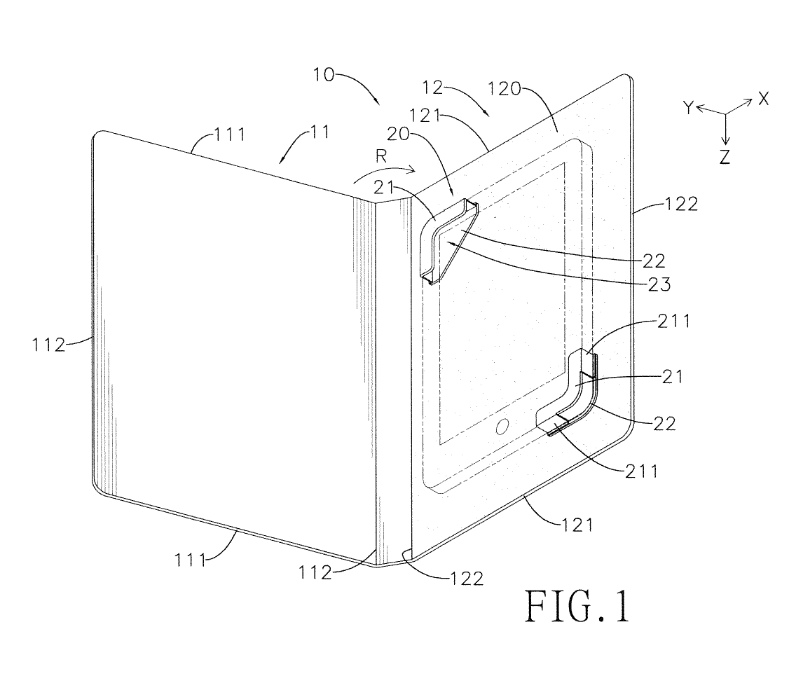

With reference to FIG. 1, a first embodiment of a size-adaptive mobile device cover in accordance with the present invention has a rectangular protection cover 10 and multiple angle holders 20.

The protection cover 10 has two cover boards and a backboard. Each cover board takes the form of a parallelogram and has a thickness. The backboard is connected between the two cover boards. In the present embodiment, the two cover boards include a first cover board 11 and a second cover board 12. The first cover board 11 has two first parallel sides 111 and two second parallel sides 112. The first parallel sides 111 of the first cover board 11 are parallel to a second axis (Y axis). The second parallel sides 112 of the first cover board 11 are parallel to a third axis (Z axis). The second cover board 12 also has two first parallel sides 121 and two second parallel sides 122. The first parallel sides 121 of the second cover board 12 are parallel to a first axis (X axis). The second parallel sides 122 of the second cover board 12 are parallel to the third axis (Z axis). The first axis and the second axis are perpendicular to the third axis.

The second cover board 12 has an inner surface and a first movable fixing portion 120. The first movable fixing portion 120 is located on the inner surface, The angle holders 20 are mounted on the first movable fixing portion 120, and serve to hold a mobile device, such as a tablet PC, a relatively large smart phone, and the like, on the first movable fixing portion 120. In the present embodiment, two angle holders 20 are diagonally mounted on the first movable fixing portion 120 to hold two corners of the mobile device and fix the mobile device on the second cover board 12. The first cover board 11 is turned an angle R toward the first axis to adjoin the second cover board 12. Accordingly, the mobile device held between the first cover board 11 and the second cover board 12 can be protected against collision, scratch and wear.

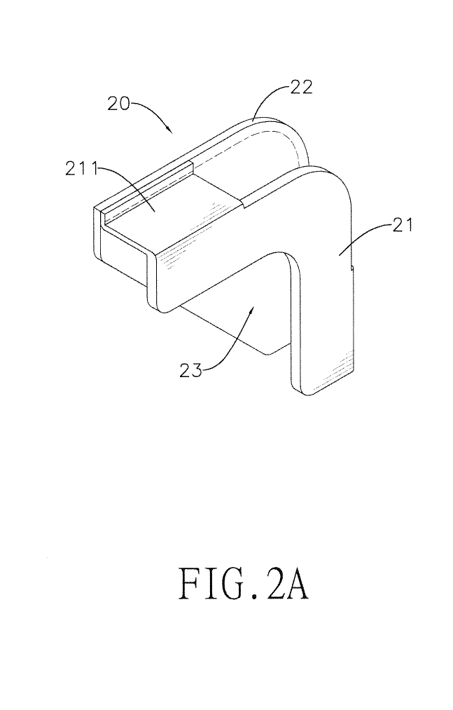

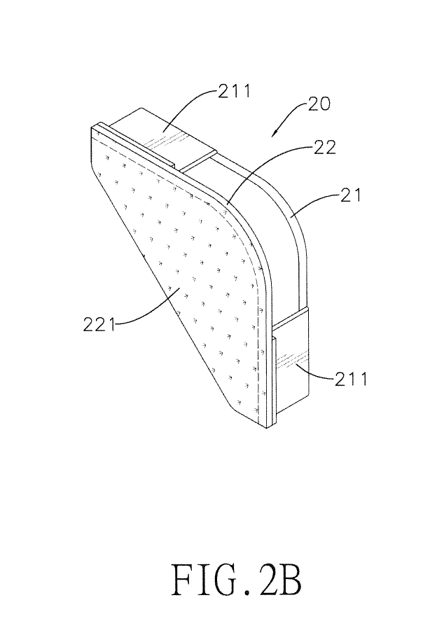

With reference to FIGS. 2A and 2B, each angle holder 20 has a first holding section 21 and a second holding section 22. The first holding section 21 is strip-shaped. The second holding section 22 is plate-shaped and has a second movable fixing portion 221. The second movable fixing portion 221 is mounted on an outer side of the second holding section 22, and is selectively and detachably mounted on the first movable fixing portion 120 of the second cover board 12. The locations of the angle holders 20 determine where the first movable fixing portion 120 is located on the second cover board 12.

The first holding section 21 is L-shaped, and has two connection portions 211. The two connection portions 211 are plate-shaped. Each connection portion 211 is formed between the second holding portion 22 and one outer edge portion of the first holding section 21 that is adjacent to a corresponding end of the first holding section 21. Given the first holding section 21, the second holding section 22 and the connection portions 211, a holding slot 23 is formed among the first holding section 21, the second holding section 22 and the connection portions 211. When the mobile device is held by the two diagonally mounted angle holders 20, the first holding section 21, the second holding section 22 and the holding slot 23 of each angle holder 20 are used to hold one of two diagonal corners of the mobile device.

In the present embodiment, the second movable fixing portion 221 is a hook and loop fastener, a touch fastener or a plastic buckle. The first movable fixing portion 120 is made of a flannel layer.

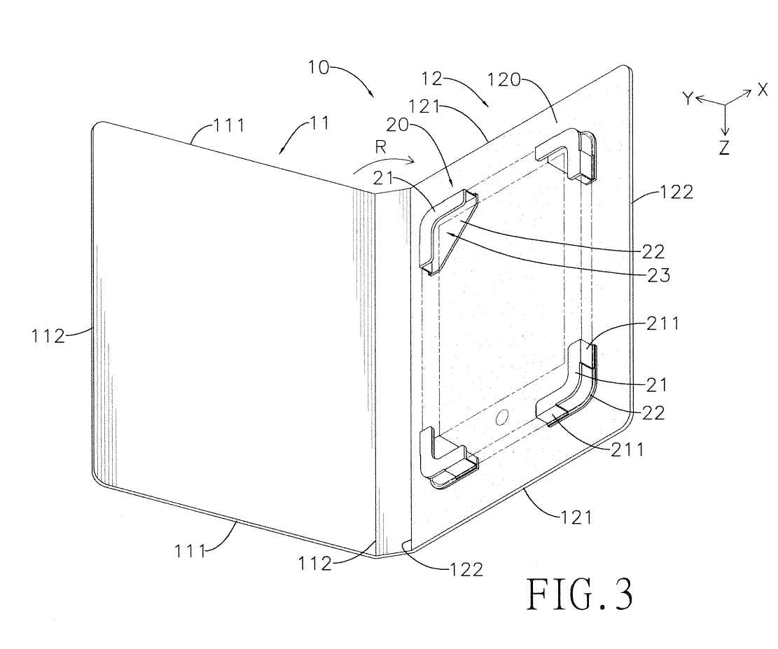

With reference to FIG. 3, a second embodiment of a size-adaptive mobile device cover in accordance with the present invention is substantially the same as the first embodiment except that the second embodiment has four angle holders 20 for fixing the mobile device. The four angle holders 20 are used to hold four corners of the mobile device for the four corners of the mobile device to be respectively fixed in the holding slots of the four angle holders 20 and then the four angle holders 20 are selectively and detachably mounted on an inner side of the second cover board 12.

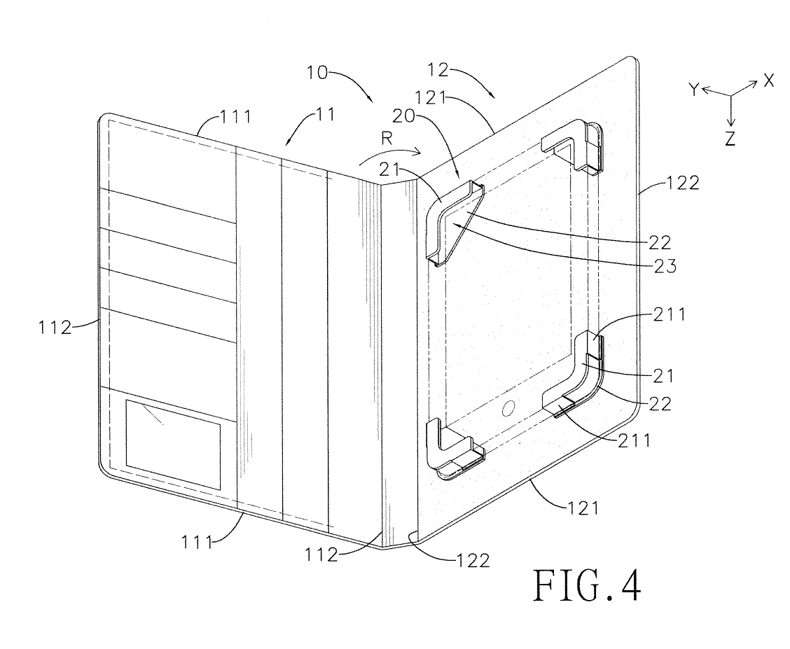

With reference to FIG. 4, a third embodiment of a size-adaptive mobile device cover in accordance with the present invention is substantially the same as the second embodiment except that the first cover board 11 has a different structure. The first cover board 11 further has multiple function pockets formed on an inner side of the first cover board 11 for users to receive documents, business cards, pictures, and the like. In addition to the foregoing fixing capability, the size-adaptive mobile device cover also has other value-added functions.

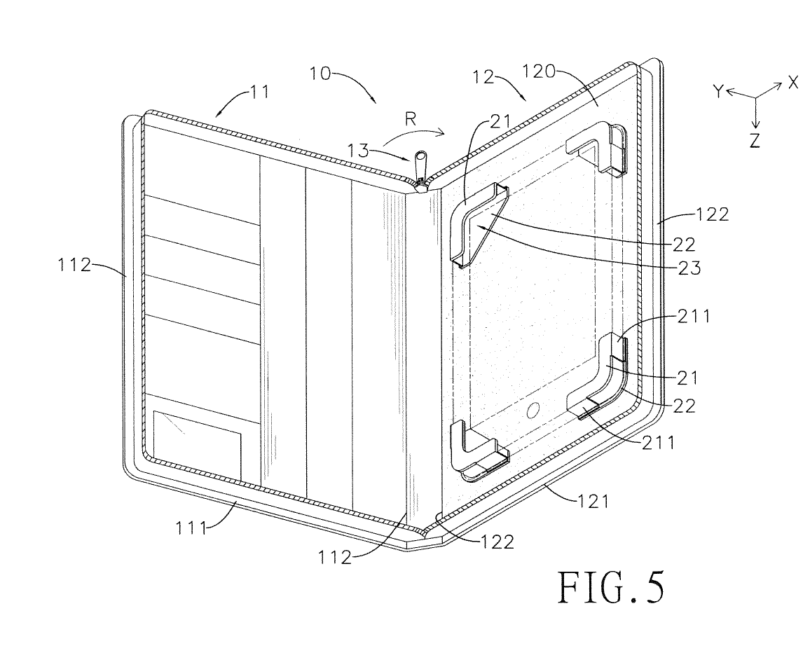

With reference to FIG. 5, a fourth embodiment of a size-adaptive mobile device cover in accordance with the present invention is substantially the same as the third embodiment except that a C-shaped opening is formed between the first cover board 11 and the second cover board 12, and a zipper 13 is mounted around an edge portion of the C-shaped opening to open or close the C-shaped opening. The zipper 13 has a head end and a tail end located between the first cover board 11 and the second cover board 12. The head end is located on one end of an inner side of the backboard, and the tail end is located on the other end of the inner side of the backboard.

After the first cover board 11 is turned an angle R toward the first axis and adjoins the second cover board 12, the C-shaped opening is closed by zippering the zipper 13 from the head end to the tail end. Accordingly, a dustproof feature and a feature of preventing the articles in the function pockets from being lost can be further provided.

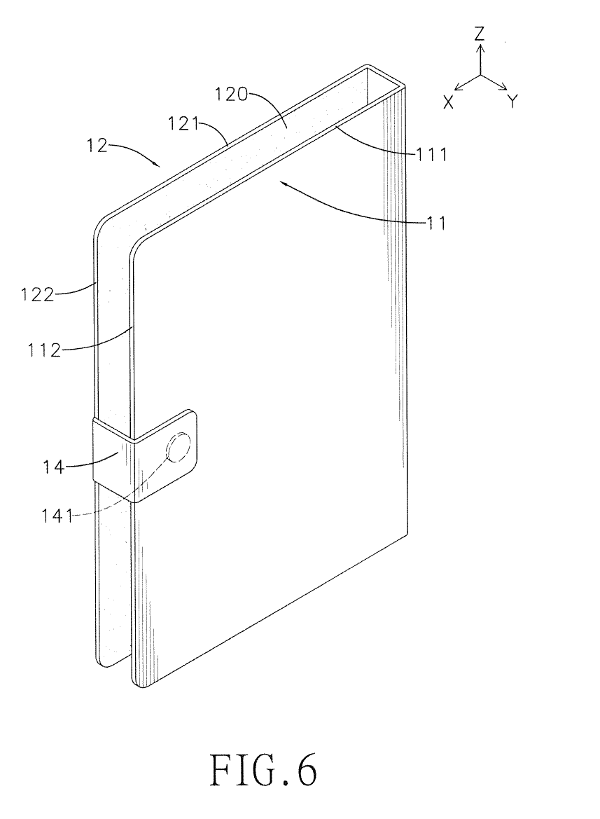

With reference to FIG. 6, a fifth embodiment of a size-adaptive mobile device cover in accordance with the present invention is substantially the same as the third embodiment except that the second cover board 12 further has a strap fastener 14. The strap fastener 14 is mounted on one of the second parallel sides 122 of the second cover board 12 and perpendicularly extends outwards, and has a magnetic button 141 mounted on an inner side of a free end of the strap fastener 14. The strap fastener 14 is bent so that the magnetic button 141 on the inner side of the free end of the strap fastener 14 is attached to an outer side of the first cover board 11, and the first cover board 11 and the second cover board 12 are tightly folded on each other.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A size-adaptive mobile device cover comprising:
a protection cover having two cover boards, wherein
one of the cover boards has:
an inner surface; and
a first movable fixing portion located on the inner surface;
multiple angle holders, each angle holder having a second movable fixing portion, and selectively and detachably mounted on the first movable fixing portion, wherein locations of the angle holders determine where the first movable fixing portion is located on the cover board on which the first movable fixing portion is formed.

2. The size-adaptive mobile device cover as claimed in claim 1, wherein each cover board takes a form of a parallelogram and has a thickness; and
the protection cover further has a backboard connected between the two cover boards.

3. The size-adaptive mobile device cover as claimed in claim 2, wherein
the two cover boards includes a first cover board and a second cover board; and
each angle holder has:
a first holding section being strip-shaped; and
a second holding section being plate-shaped, wherein the second movable fixing portion of the angle holder is mounted on an outer side of the second holding section

4. The size-adaptive mobile device cover as claimed in claim 3, wherein the first holding section of each angle holder is L-shaped and has two connection portions, and each connection portion is formed between the second holding portion and one outer edge portion of the first holding section of the angle holder that is adjacent to a corresponding end of the first holding section of the angle holder.

5. The size-adaptive mobile device cover as claimed in claim 4, wherein each angle holder further has a holding slot formed among the first holding section, the second holding section and the connection portions of the angle holder.

6. The size-adaptive mobile device cover as claimed in claim 5, wherein the multiple angle holders include four angle holders, and the four angle holders are detachably formed on an inner side of the second cover board with the second movable fixing portions of the angle holders to be adapted to correspond to four corners of the mobile device for the four corners of the mobile device to be respectively fixed in the holding slots of the four angle holders.

7. The size-adaptive mobile device cover as claimed in claim 3, wherein the second cover board further has multiple function pockets mounted on an inner side of the first cover board.

8. The size-adaptive mobile device cover as claimed in claim 3, wherein a C-shaped opening is formed between the first cover board and the second cover board, and a zipper is mounted around an edge portion of the C-shaped opening to open or close the C-shaped opening.

9. The size-adaptive mobile device cover as claimed in claim 4, wherein a C-shaped opening is formed between the first cover board and the second cover board, and a zipper is mounted around an edge portion of the C-shaped opening to open or close the C-shaped opening.

10. The size-adaptive mobile device cover as claimed in claim 5, wherein a C-shaped opening is formed between the first cover board and the second cover board, and a zipper is mounted around an edge portion of the C-shaped opening to open or close the C-shaped opening.

11. The size-adaptive mobile device cover as claimed in claim 6, wherein a C-shaped opening is formed between the first cover board and the second cover board, and a zipper is mounted around an edge portion of the C-shaped opening to open or close the C-shaped opening.

12. The size-adaptive mobile device cover as claimed in claim 7, wherein a C-shaped opening is formed between the two cover boards, and a zipper is mounted around an edge portion of the C-shaped opening to open or close the C-shaped opening.

13. The size-adaptive mobile device cover as claimed in claim 3, wherein the second cover board further has a strap fastener, the strap fastener is mounted on one edge of the second cover board opposite to the backboard and extends toward the first cover board, and has a magnetic button mounted on an inner side of a free end of the strap fastener, the strap fastener is bent so that the magnetic button is attached to an outer side of the first cover board, and the first cover board and the second cover board are folded on each other.

14. The size-adaptive mobile device cover as claimed in claim 4, wherein the second cover board further has a strap fastener, the strap fastener is mounted on one edge of the second cover board opposite to the backboard and extends toward the first cover board, and has a magnetic button mounted on an inner side of a free end of the strap fastener, the strap fastener is bent so that the magnetic button is attached to an outer side of the first cover board, and the first cover board and the second cover board are folded on each other.

15. The size-adaptive mobile device cover as claimed in claim 5, wherein the second cover board further has a strap fastener, the strap fastener is mounted on one edge of the second cover board opposite to the backboard and extends toward the first cover board, and has a magnetic button mounted on an inner side of a free end of the strap fastener, the strap fastener is bent so that the magnetic button is attached to an outer side of the first cover board, and the first cover board and the second cover board are folded on each other.

16. The size-adaptive mobile device cover as claimed in claim 6, wherein the second cover board further has a strap fastener, the strap fastener is mounted on one edge of the second cover board opposite to the backboard and extends toward the first cover board, and has a magnetic button mounted on an inner side of a free end of the strap fastener, the strap fastener is bent so that the magnetic button is attached to an outer side of the first cover board, and the first cover board and the second cover board are folded on each other.

17. The size-adaptive mobile device cover as claimed in claim 7, wherein the second cover board further has a strap fastener, the strap fastener is mounted on one edge of the second cover board opposite to the backboard and extends toward the first cover board, and has a magnetic button mounted on an inner side of a free end of the strap fastener, the strap fastener is bent so that the magnetic button is attached to an outer side of the first cover board, and the first cover board and the second cover board are folded on each other.

18. The size-adaptive mobile device cover as claimed in claim 8, wherein the second movable fixing portion is a hook and loop fastener, a touch fastener or a plastic buckle, and the first movable fixing portion is made of a flannel layer.

19. The size-adaptive mobile device cover as claimed in claim 9, wherein the second movable fixing portion is a hook and loop fastener, a touch fastener or a plastic buckle, and the first movable fixing portion is made of a flannel layer.

20. The size-adaptive mobile device cover as claimed in claim 10, wherein the second movable fixing portion is a hook and loop fastener, a touch fastener or a plastic buckle, and the first movable fixing portion is made of a flannel layer.
